(19) United States
(12) Patent Application Publication
(10) Pub. No.: US 2018/0007658 A1
(43) Pub. Date: Jan. 4, 2018

(54) RESOURCE ALLOCATION METHOD FOR PAGING MESSAGE, NETWORK NODE AND USER EQUIPMENT

(71) Applicant: Sharp Kabushiki Kaisha, Sakai City, Osaka (JP)

(72) Inventors: XINGYA SHEN, Shanghai (CN); RENMAO LIU, Shanghai (CN); FANGYING XIAO, Shanghai (CN)

(21) Appl. No.: 15/540,392

(22) PCT Filed: Dec. 28, 2015
(86) PCT No.: PCT/CN2015/099197

§ 371 Date: Jun. 28, 2017

(30) Foreign Application Priority Data
Dec. 30, 2014 (CN) 201410843340.0

(51) Int. Cl. H04W 68/02; H04W 4/00; H04W 72/04

(52) U.S. Cl. CPC H04W 68/02; H04W 72/0453; H04W 4/005; H04W 72/042

(57) ABSTRACT

Provided are a frequency domain resource allocation method for a paging message of an MTC user equipment, a corresponding network node and a user equipment. The method according to embodiments of the present invention comprises: allocating a resource block set for sending a paging message to an MTC user equipment; and sending resource allocation indication information to the MTC user equipment, with the resource allocation indication information including first information indicating the position of a starting resource block of the resource block set and second information indicating the number of resource blocks which are continuously allocated and included in the resource block set. By means of the embodiments of the present invention, a user equipment can determine the position of a paging message on a frequency domain, so as to read the paging message.

### TECHNICAL FIELD

The present invention relates to the technical field of wireless communication. More particularly, the present invention relates to a resource allocation method for a paging message in machine type communication (MTC), and a network node and a user equipment.

### BACKGROUND

The long-term evolution (LTE) project, deployed by the Third Generation Mobile Communications Partnership Program (3GPP) organization, is designed to provide an increasingly diverse future mobile communication service. Wireless cellular communication has increasingly become an integral part of public life and work. Orthogonal frequency division multiple access (OFDMA) and multi-antenna (MIMO) techniques are introduced in the first release (i.e., Release 8) of 3GPP LTE. 3GPP Release 10, upon the evaluation and testing of International Telecommunications Union, has officially become the fourth generation global mobile communication standard LTE-Advanced. In the LTE-Advanced standard, the carrier aggregation (CA) and relay technology are introduced to enhance uplink/downlink MIMO technology and also support heterogeneous network (HetNet) deployment.

In order to meet future market demands for home equipment communications and large-scale Internet of Things (IOT) deployments, the 3GPP has decided to introduce low-cost Machine Type Communication (MTC) in LTE and upgraded releases thereof, migrate the MTC service from the current GSM network support to LTE network support, and define a number of new types of user equipment (UE). One of the new types of user equipment is called low-cost MTC user equipment (Low-cost MTC UE). This type of MTC UE supports MTC service in all duplex modes of existing LTE networks and has the following performances: 1) single receiving antenna; 2) a maximum downlink and uplink transport block size (TBS) of 1000 bits; 3a) the baseband bandwidth of the downlink data channel is reduced to 1.4 MHz, the bandwidth of the downlink control channel is consistent with the bandwidth of the network side system, and the uplink channel bandwidth and the downlink radio frequency part are consistent with those of the user equipment in the existing LTE network; and 3b) the baseband bandwidth of the downlink/uplink control channel and the data channel is reduced to 1.4 MHz.

MTC is a data communication service without human participation. Large-scale MTC user equipment deployment can be used in fields, such as security, tracking, payment, measurement and consumer electronics and specifically relates to applications, including video surveillance, supply chain tracking, smart electric meters, remote monitoring and, and the like.

MTC user equipment requires low power consumption and supports low data transmission rate and low mobility. At present, the LTE system is mainly for human-to-human (H2H) communication services. Therefore, the key to achieve the scale competitive advantage and application prospect of MTC service is that the LTE network supports the low-cost MTC user equipment.

Some MTC user equipments are installed in the basement of a residential building or at a position under the protection of an insulating foil, a metal window or the thick wall of a traditional building; as compared with conventional equipment terminals (such as mobile phones, tablet computers, etc.) in the LTE network, the air interfaces of the MTC user equipments will obviously suffer from more serious penetration losses. 3GPP has decided to study the LTE network to provide the MTC user equipment with a solution design and performance evaluation for an additional coverage enhancement service of 20 dB/15 dB. Note that the MTC user equipments located in poor network coverage areas have the characteristics of a very low data transmission rate, a very relaxed delay requirement, and limited mobility. For the characteristics of the MTC user equipments, the LTE network can further optimize some signaling and/or channels to support the MTC user equipments. The 3GPP requires the provision of certain LTE network coverage enhancement for newly defined MTC user equipments and other user equipments operating the MTC service (e.g., very relaxed delay requirement), for example, the LTE frequency division duplex (FDD) network is provided with network coverage enhancement of 15 dB. In addition, not all user equipments operating the MTC service requires the same network coverage enhancement.

At a 3GPP RAN #64 meeting held in June 2014, a new work item on Rel-13-oriented even lower complexity and enhanced coverage for MTC was proposed (see NPL: RP-140990 New Work Item on Even Lower Complexity and Enhanced Coverage LTE UE for MTC, Ericsson, NSN). According to description of this work item, the LTE Rel-13 system needs to support an MTC user equipment (hereinafter referred to as a narrowband MTC UE) having uplink/downlink 1.4 MHz RF bandwidth to operate at any system bandwidth (e.g., 1.4 MHz, 3 MHz, 5 MHz, 10 MHz, 15 MHz, 20 MHz, etc.) and provides coverage enhancement for such MTC user. In the system design, low-cost MTC users and enhanced coverage MTC users adopt a unified design. One of the main objectives of this work item is to reduce the energy consumption of the MTC user equipment.

In the case that the 3GPP LTE user equipment operates the MTC service and is under the coverage enhancement mode, the coverage enhancement design and configuration of physical layer channels such as (E) PDCCH/PDSCH/PDCCH/PUSCH is a standardization work. According to the discussion at the 3GPPRAN1 #74 meeting, after the initial access is completed, for any physical channel that requires retransmission, a configuration mode of the physical channel depends on the base station side. However, a delay of 2 to 10 seconds will be generated when the MTC user equipment combines and demodulates a large amount of repeating data. This delay increases the power consumption of the MTC user equipment. According to the decision made at the 3GPP RANI #74b meeting, for the MTC user equipment requiring coverage enhancement, the transmission of the data channel shall be performed after the transmission of the control channel is completed. Therefore, in order to reduce the power consumption of the user equipment, a physical downlink control channel may not be required for transmission of a paging message of the MTC user equipment requiring coverage enhancement. Moreover, since the low complexity MTC UE has a similar information transmission mechanism with the enhanced coverage MTC user equipment, it is necessary to design a paging message transmission mechanism that is applicable to the enhanced coverage MTC user equipment and/or the low complexity or low cost MTC user equipment, that is, it is necessary to design a mechanism for transmitting a paging message without a corresponding physical downlink control channel. Therefore, the resource allocation of paging information for the MTC user equipment in a frequency domain needs to be redesigned.

### SUMMARY

The present invention is directed to providing a frequency domain resource allocation mechanism for a paging message, that is applicable to, for example, an enhanced coverage MTC user equipment and/or a low complexity or low cost MTC user equipment, and a network node and a user equipment that perform the mechanism.

A frequency domain resource allocation method for a paging message performed by a network node is provided according to a first aspect of the present invention, which includes: allocating a resource block set for transmitting a paging message to an MTC user equipment; and transmitting resource allocation indication information to the MTC user equipment, where the resource allocation indication information includes first information indicating a position of a starting resource block of the resource block set and second information indicating the number of consecutively allocated resource blocks included in the resource block set.

A frequency domain resource allocation method for a paging message, with Machine Type Communication (MTC) user equipment as a receiver, is provided according to a second aspect of the present invention, which includes: receiving, from a network node, resource allocation indication information for a paging message, where the resource allocation indication information includes first information indicating a position of a starting resource block of a resource block set allocated for transmitting the paging message to the MTC user equipment and second information indicating the number of consecutively allocated resource blocks included in the resource block set; and applying the received resource allocation indication information.

A network node in a wireless telecommunication system supporting MTC is provided according to a third aspect of the present invention, which includes:

an allocation module, configured to allocate a resource block set for transmitting a paging message to an MTC user equipment; and a communication module, configured to transmit resource allocation indication information to the MTC user equipment, where the resource allocation indication information includes first information indicating a position of a starting resource block of the resource block set and second information indicating the number of consecutively allocated resource blocks included in the resource block set.

A machine type communication MTC user equipment is provided according to a fourth aspect of the present invention, which includes: a communication module, configured to receive, from a network node, resource allocation indication information for a paging message, where the resource allocation indication information includes first information indicating a position of a starting resource block of a resource block set allocated for transmitting the paging message to the MTC user equipment and second information indicating the number of consecutively allocated resource blocks included in the resource block set; and a configuration module, configured to apply the received resource allocation indication information.

In some embodiments of the present invention, the network node may be a base station or a mobility management entity (MME).

In some embodiments of the present invention, the resource allocation indication information can be carried by a system information block or by a non access stratum (NAS) message.

In some embodiments of the present invention, different frequency domain resources (i.e., resource block set) can be allocated for paging messages for MTC user equipments at different coverage enhancement levels. Correspondingly, the resource allocation indication information may contain multiple pieces of the first information and multiple pieces of the second information corresponding to the different coverage enhancement levels.

In some embodiments of the present invention, a lifespan can be set for the received resource allocation indication information in the MTC user equipment. If the resource allocation indication information applied to the MTC user equipment exceeds the lifespan, the resource allocation indication information can be deleted.

In some embodiments of the present invention, the MTC user equipment maintains valid resource allocation indication information in a radio resource control connect (RRC CONNECT) state and/or a radio resource control idle (RRC IDLE) state.

In some embodiments of the present invention, when the MTC user equipment needs to acquire a paging message, the MTC user equipment, according to the applied (i.e., valid) resource allocation indication information, determines a starting position of the paging message in the frequency domain and determines the number of physical resource blocks occupied by the paging message in the frequency domain.

### BRIEF DESCRIPTION OF THE DRAWINGS

Above and other features of the present invention will be more obvious from the detailed description below, with reference to the drawings, in which

FIG. 1 is a flow chart of a frequency domain resource allocation method for a paging message according to an embodiment of the present invention, which can be implemented in an MTC communication system;

FIG. 2 is a schematic structural diagram illustrating a network node according to an embodiment of the present invention;

FIG. 3 is a schematic structural diagram illustrating an MTC user equipment according to an embodiment of the present invention; and

FIG. 4 is a schematic diagram illustrating a resource block set carrying different levels of paging messages.

### DETAILED DESCRIPTION OF EMBODIMENTS

A domain frequency resource allocation method for a paging message applicable to a MTC user equipment requiring additional coverage enhancement or a low complexity/low cost MTC user equipment and other user equipment supporting a delay-tolerant MTC service and requiring certain coverage enhancement, and a network node and an MTC user equipment (UE) that perform the method according to the present invention will be described in detail below in conjunction with the drawings and the embodiments. Note that the present invention is not limited to the embodiments described below. In addition, for convenience, specific details about the related art not directly related to the present invention may be omitted so as not to obscure the present invention.

In the following description, an LTE mobile communication system and subsequent evolved releases thereof are used as exemplary application environments to describe multiple embodiments of the present invention. Note that, however, the present invention is not limited to the following embodiments and may be applicable to more other wireless communication systems, such as a future 5G cellular communication system. In the following, unless otherwise indicated, each of communication systems, network nodes and user equipments mentioned supports MTC.

In an existing LTE system, a SystemInformationBlockType2 message contains a pcch-Config information element (IE) which is used for configuring a paging frame (PF) and a paging occasion (PO) for a user to receive a paging message in the time domain. As described above, for the enhanced coverage MTC user equipment and/or the low complexity or low cost MTC user equipment, the physical downlink control channel corresponding to the paging message is not available for transmission; therefore, configuration parameters (such as the frequency domain resource allocation parameters for the paging message) for determining how the paging message is carried in the frequency domain need to be transmitted to the user. Considering that MTC user equipment also needs to receive the paging message in the RRC IDLE sate, the configuration parameters for the paging message according to an embodiment of the present invention should be carried in system information or a non access stratum (NAS) message.

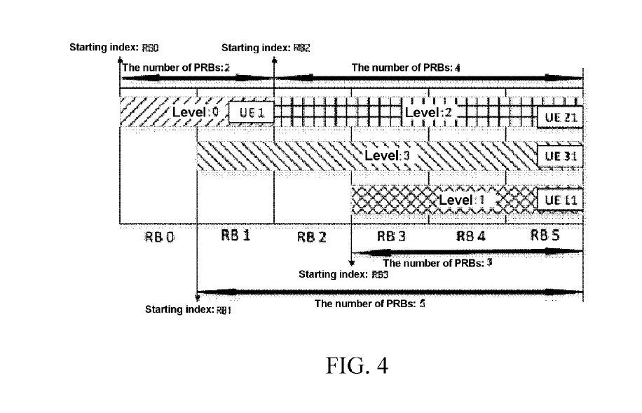

The inventor recognizes that a physical resource block to which a paging message is mapped in a subframe is determined at least based on two parameters, such as a starting position (e.g., a position of a starting resource block) of a resource block set carrying the paging message and the size of the resource block set (e.g., the number of consecutively allocated resource blocks). FIG. 4 illustrates an example of a resource block set for carrying different levels of paging messages, particularly illustrates the relationship between the size and a starting position of each resource block set and a level of a paging message. The level of the paging message refers to a repeating level of the paging message mapped to a physical channel, and different levels of paging messages correspond to different coverage enhancement levels.

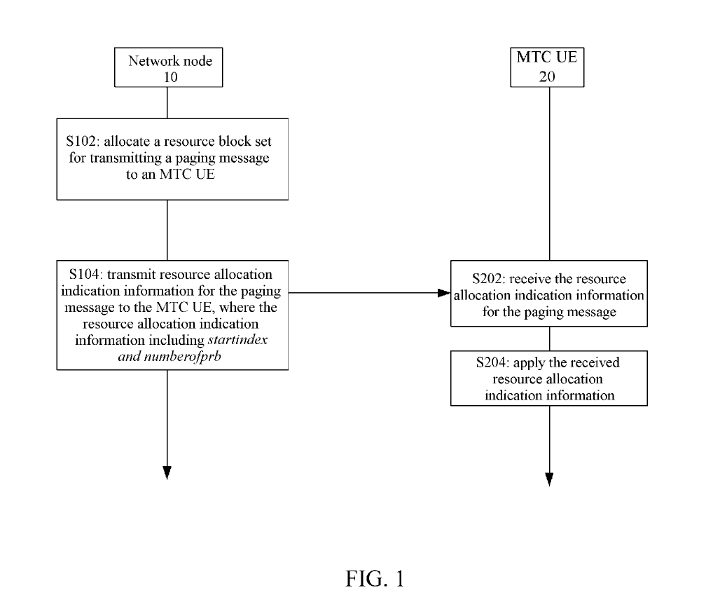

Based on the above consideration, in an embodiment of the present invention, a position of a paging message of the MTC user equipment in a frequency domain can be provided through information indicating a starting position of a resource block set for carrying the paging message and information indicating the number of the resource block set in the case that the physical downlink control channel corresponding to the paging message is not available for transmission. The following description sets forth the details with reference to FIG. 1.

FIG. 1 is a flow chart of a frequency domain resource allocation method for a paging message according to an embodiment of the present invention which can be implemented in an MTC communication system. The MTC communication system may include one or more network nodes 10 supporting MTC and one or more user equipment MTU UE 20 supporting MTC (MTC UE). Although FIG. 1 only illustrates one network node 10 and one MTC UE, the present invention is not limited in this aspect. It also should be understood that the MTC communication system may include an access network and a core network. The network node 10 may be a base station and also may be a mobility management entity (MME) in the core network.

As illustrated in FIG. 1, at step S102, the network node 10 determines resource allocation for a paging resource. Particularly, the network node 10 allocates a resource block set for transmitting the paging message to the MTC user equipment.

Next, at step S104, resource allocation indication information is transmitted to the user equipment. The resource allocation indication information includes first information (e.g., marked as startindex) indicating a position of a starting resource block of the resource block set and second information (e.g., marked as numberofprb) indicating the number of consecutively allocated resource blocks included in the resource block set.

Preferably, the resource allocation indication information contains multiple pieces of the first information and multiple pieces of the second information corresponding to different coverage enhancement levels. In other words, the resource allocation indication information contains multiple types of paging message frequency domain resource allocation corresponding to different coverage enhancement levels.

At step S202, the MTC UE 20 receives the resource allocation indication information from the network node.

Accordingly, at step S204, the MTC UE 20 can apply the received resource allocation indication information. For example, the received resource allocation indication information can be applied to acquisition of configuration parameters related to the paging message.

Considering that in the current system, the configuration information of paging control channel (PCCH) is included in system information, in some embodiments of the present invention, the configuration parameter related to the paging message may be included in the system information. In such case, the network node 10 in FIG. 1 may be a base station. At step S102, the resource allocation indication information can be carried by a system information block broadcasted by the base station to the user equipment.

In addition, considering that the paging message is initiated by a network side, in other embodiments of the present invention, the configuration parameter related to the paging message also may be included in a non access stratum (NAS) message. In such case, the network node 10 in FIG. 1 may be the mobility management entity in the core network. At step S102, the resource allocation indication information can be carried by the NAS message. It should be understood that the resource allocation indication information in the NAS message is transmitted transparently with respect to the base station. The base station does not need to interpret the resource allocation indication information.

The two cases are described below in detail.

A. The System Information Contains the Parameter Related to the Paging Message

For an MTC user equipment requiring additional coverage enhancement or a low complexity/low cost MTC user equipment, new system information will be introduced. As an example, according to the present invention, the system information for the MTC user equipment may be called SI_MTC or SystemInformationBlock18. The system information block at least contains information elements related to paging message configuration of the MTC user equipment. For example, two information elements, numberofprb and startindex, may be introduced in the SystemInformationBlock18, where numberofprb is used for indicating the number of consecutively allocated resource blocks and startindex is used for indicating the position of the starting resource block. If SI_MTC is divided into multiple system information blocks, the information elements numberofprb and startindex may be included in one of the system information blocks; for example, the information elements numberofprb and startindex may be included in the first system information block for the MTC user equipment.

The value of the information element numberofprb may be an integer defined by value ranges (e.g., a value range from 1 to 6) having a one-to-one correspondence with coverage enhancement levels. For example, L0 represents coverage enhancement level 0, i.e., referring to a user equipment not requiring coverage enhancement, a value of the information element corresponding to L0 is an integer (e.g., 1 to 6) in a defined range; L1 represents coverage enhancement level 1, i.e., referring to a user equipment requiring coverage enhancement (e.g., enhancement of 1 to 5 dB), a value of the information element corresponding to L1 is an integer (e.g., 1 to 6) in a defined range; L2 represents coverage enhancement level 2, i.e., referring to a user equipment requiring coverage enhancement (e.g., enhancement of 6 to 10 dB), a value of the information element corresponding to L2 is an integer (e.g., 1 to 6) in a defined range; L3 represents coverage enhancement level 3, i.e., referring to a user equipment requiring coverage enhancement (e.g., enhancement of 11 to 15 dB), a value of the information element corresponding to L3 is an integer (e.g., 1 to 6) in a defined range. Here, the user equipment requiring coverage enhancement means that the physical channel received by the user equipment requires coverage enhancement; and the coverage enhancement of the physical channel is mainly achieved in two ways: repetition transmission of control channels such as PBCH/EPDCCH/PUCCH/PRACH; or subframe binding transmission of data channels such as PDSCH/PUSCH.

The value of the information element startindex may be an integer defined by value ranges (e.g., a value range from 0 to 5) having a one-to-one correspondence with coverage enhancement levels. For example, referring to Table 1 below, L0 represents coverage enhancement level 0, i.e., referring to a user equipment not requiring coverage enhancement, a value of the information element corresponding to L0 is an integer (e.g., 0 to 5) in a defined range; L1 represents coverage enhancement level 1, i.e., referring to a user equipment requiring coverage enhancement (e.g., enhancement of 1 to 5 dB), a value of the information element corresponding to L1 is an integer (e.g., 0 to 5) in a defined range; L2 represents coverage enhancement level 2, i.e., referring to a user equipment requiring coverage enhancement (e.g., enhancement of 6 to 10 dB), a value of the information element corresponding to L2 is an integer (e.g., 0 to 5) in a defined range; L3 represents coverage enhancement level 3, i.e., referring to a user equipment requiring coverage enhancement (e.g., enhancement of 11 to 15 dB), a value of the information element corresponding to L3 is an integer (e.g., 0 to 5) in a defined range. Here, the user equipment requiring coverage enhancement means that the physical channel received by the user equipment requires coverage enhancement; and the coverage enhancement of the physical channel is mainly achieved in two ways: repetition transmission of control channels such as PBCH/EPDCCH/PUCCH/PRACH; or subframe binding transmission of data channels such as PDSCH/PUSCH.

In the embodiment of the present invention, it is possible to define an information element (e.g., called PCCH-Config-r 13) similar to the existing PCCH-Config and including both information elements numberofprb and startindex as the resource allocation indication information for the paging message of the MTC user equipment, disclosed by the present invention. Refer to Section 6.3.2 radioResourceConfigCommon information element of 3GPP TS 36.331 v12.3.0 “3rd Generation Partnership Project; Technical Specification Group Radio Access Network; Evolved Universal Terrestrial Radio Access (E-UTRA); Radio Resource Control (RRC); Protocol specification” for details about PCCH-config.

The formats of PCCH-Config-r13 may be as shown in Table 1 below (the difference from the existing PCCH-Config is highlighted in bold).

TABLE 1

| | |
|---|---|
| PCCH-Config-r13 ::= | SEQUENCE { |

| | |
|---|---|
| defaultPagingCycle | ENUMERATED { |
| | rf32, rf64, rf128, rf256}, |
| nB | ENUMERATED { |
| | fourT, twoT, oneT, halfT, quarterT, |
| | oneEighthT, oneSixteenthT, |
| | oneThirtySecondT} |

| | |
|---|---|
| numberofprb ::= | SEQUENCE { |

| | |
|---|---|
| L0 | INTEGER (1...6) |
| L1 | INTEGER (1...6) |
| L2 | INTEGER (1...6) |
| L3 | INTEGER (1...6) |
| } | |
| startindex ::= | SEQUENCE { |
| L0 | INTEGER (0...5) |
| L1 | INTEGER (0...5) |
| L2 | INTEGER (0...5) |
| L3 | INTEGER (0...5) |
| } | |
| } | |

The information element PCCH-Config-r13 is used for configuring parameters of paging control channels for an MTC user equipment requiring additional coverage enhancement or a low complexity/low cost MTC user equipment. The information element radioResourceConfigCommonSlB defined in Section 6.3.2 of 3GPP TS 36.331 V12.3.0 can be modified to contain the information element PCCH-Config-r13. The modified information element radioResourceConfigCommonSlB may be as shown in Table 2 below (the modifications are highlighted in bold).

TABLE 2
RadioResourceConfigCommonSIB ::= SEQUENCE {

| | |
|---|---|
| rach-ConfigCommon | RACH-ConfigCommon, |
| bcch-Config | BCCH-Config, |
| pcch-Config | PCCH-Config, |
| pcch-Config-r13 | PCCH-Config-r13, |
| prach-Config | PRACH-ConfigSIB, |
| pdsch-ConfigCommon | PDSCH-ConfigCommon, |
| pusch-ConfigCommon | PUSCH-ConfigCommon, |
| pcch-ConfigCommon | PUCCH-ConfigCommon, |
| soundingRS-UL-ConfigCommon | SoundingRS-UL-ConfigCommon, |
| uplinkPowerControlCommon | UplinkPowerControlCommon, |
| ul-CyclicPrefixLength | UL-CyclicPrefixLength, |

| ..., | | |
|---|---|---|
| [[uplinkPowerControlCommon-v1020 UplinkPowerControlCommon-v1020 | | OPTIONAL -- Need OR |
| ]], | | |
| [[rach-ConfigCommon-v12xy | RACH-ConfigCommon-v12xy | OPTIONAL -- Need OR |
| ]] | | |

}

The modified information element radioResourceConfigCommonSlB containing the information element PCCH-Config-r13 may be contained in the system information for the MTC user equipment requiring additional coverage enhancement or the low complexity/low cost MTC user equipment, for example, may be contained in SystemInformationBlock20.

It is required to ensure that there is a valid version of the system information (e.g., called SI_MTC or SystemInformationBlockType20) required by the MTC user equipment no matter the MTC user equipment is in an RRC_IDLE state or in an RRC_CONNECTED state or exits a power saving mode (PSM). In the user equipment, a lifespan (e.g., 3 hours) may be set for the received system information (or specifically the resource allocation indication information for the paging message, included in the received system information). If the valid time of the system information stored in the user equipment reaches the lifespan, the system information is deleted, unless otherwise stated. If the unique valid version is deleted, system information is read again.

After receiving the required system information (e.g., SysteminformationBlockType20), the MTC user equipment needs to apply configuration information included in radioResourceConfigCommonSIB.
A. When acquiring the paging message, over the frequency domain resources, the user equipment needs to: determine the starting position of the paging message in the frequency domain through the information element startindex in SystemInformationBlockType20; and
B. determine the number of physical resource blocks occupied by the paging message in the frequency domain through the information element numberofprb in SystemInformationBlockType20.

B. The NAS Information Contains the Parameter Related to the Paging Message

For the MTC user equipment requiring additional coverage enhancement or the low complexity/low cost MTC user equipment, new NAS information will be introduced. According to the present invention, NAS information for the MTC user equipment may be called NAS_MTC message. The NAS_MTC message at least contains information elements related to paging message configuration of the MTC user equipment. For example, two information elements, numberofprb and startindex, may be introduced in the NAS-MTC message, wherein numberofprb is used for indicating the number of consecutively allocated resource blocks and startindex is used for indicating a starting position of resource blocks.

In some embodiments of the present invention, it is possible to define an information element (e.g., called a Downlink MTC non access stratum Transport message, or called Downlink MTC NAS Transport) similar to the existing Downlink NAS Transport and including both information elements numberofprb and startindex as the resource allocation indication information for the paging message of the MTC user equipment, disclosed by the present invention. Downlink NAS Transport messages can refer to Downlink NAS Transport defined in section 8.2.12 of the existing TS 24.301 Non-Access-Stratum (NAS) protocol for Evolved Packet System (EPS).

Specifically, the formats of the Downlink MTC NAS Transport message may be as shown in Table 3 below.

Message type: Downlink MTC NAS Transportmessage
Meaning: dual (i.e., identical for both the network side and the user equipment).
Direction: network→user equipment
(Modifications are highlighted in bold)

TABLE 3

| | IE type and | Exis- | | |
|---|---|---|---|---|
| IE/group name | reference | tence | Format | Length |
| Protocol discriminator | See below | M | V | 12 |
| Security header type | See below | M | V | 12 |
| Downlink MTC NAS | See below | M | V | 1 |
| transport message identity | | | | |
| MTC NAS message container | See below | M | LV | 3-252 |

As shown in Table 3, the Downlink MTC NAS transport message contains four information elements, i.e., a Protocol discriminator information element, a Security header type information element, a Downlink MTC NAS transport message identity information element, and an MTC NAS message container information element.

The first four bits in the first byte include the Protocol discriminator information element with a value of 0010. The specific formats of the Protocol discriminator information element can refer to Section 11.2.3.1 of TS 24.007.

The last four bits in the first byte include the Security header type information element, a value of which can refer to Section 9.3.1 Security header type in TS 24.301.

The second byte includes the Downlink NAS transport message identity information element. The Message type information element described in Section 9.8.1 of TS 24.301, can be modified to contain the Downlink NAS transport message identity information element. The modified information element may have a value of 01101010.

With respect to the MTC NAS message container information element, the NAS message container information element described in Section 9.9.3.22 of TS 24.301 can be modified to contain the MTC NAS message container information element. The format of the MTC NAS message container information element may be as shown in Table 4, where the information elements numberofprb and startindex are included in the MTC NAS message container information element as shown in Table 4.

TABLE 4
MTC NAS message containerinformation element

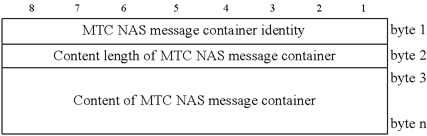

As described above, the Downlink MTC NAS transport message contains two information elements: numberofprb and startindex.

When acquiring the paging message, over the frequency domain resources, the user equipment needs to:
A. determine the starting position of the paging message in the frequency domain through the information element startindex in NAS-MTC-PDU in the Downlink NAS message; and
B. determine the number of physical resource blocks occupied by the paging message in the frequency domain through the information element numberofprb in NAS-MTC-PDU in the Downlink NAS message.

FIG. 2 is a schematic structural diagram of a network node 10 according to an embodiment of the present invention. In some embodiments, the network node 10 is a base station. In other embodiments, the network node 10 may be a mobility management entity in a core network.

As illustrated in FIG. 2, the network node 10 may include an allocation module 12 and a communication module 14.

The allocation module 12 may be configured to allocate a resource block set for transmitting a paging message to an MTC user equipment.

The communication module may be configured to transmit resource allocation indication information to the MTC user equipment. The resource allocation indication information includes first information (e.g., the above-described startindex) indicating a position of a starting resource block of the resource block set and second information (e.g., the above-described numberofprb) indicating the number of consecutively allocated resource blocks included in the resource block set.

In some embodiments, the communication module 14 is further configured to carry the resource allocation indication information by a system information block or by a non access stratum (NAS) message.

In some embodiments, the resource allocation indication information for the paging message transmitted by the network node 10 contains multiple pieces of the first information and multiple pieces of the second information corresponding to different coverage enhancement levels.

In some embodiments of the present invention, the network node 10 further includes a memory module 16 used for storing information to be transmitted, such as information related to resource allocation for a paging message, the size of the physical resource block set, a paging message, and the like.

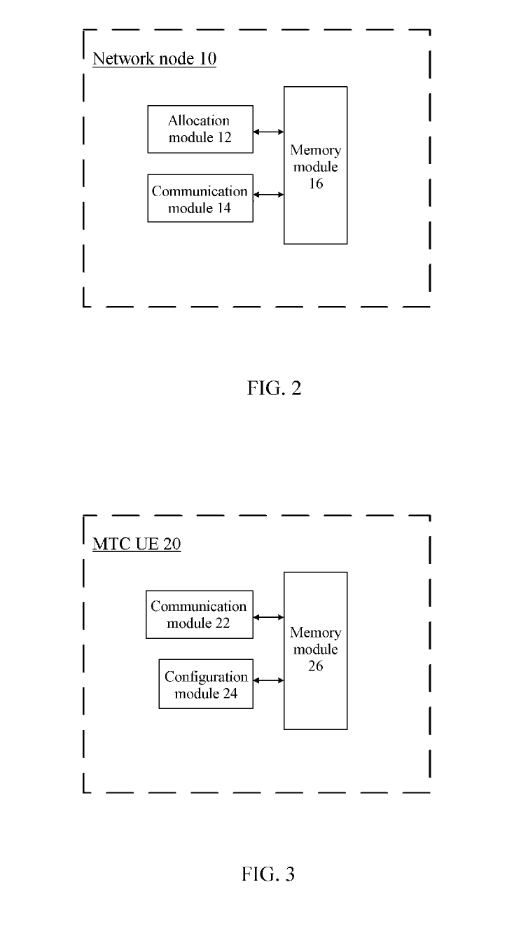

FIG. 3 is a schematic structural diagram of an MTC user equipment 20 according to an embodiment of the present invention; and as illustrated in FIG. 3, the MTC UE 20 includes a communication module 22 and a configuration module 24.

The communication module 22 may be configured to receive resource allocation indication information for a paging message from the network node. The resource allocation indication information includes first information (e.g., the above-described startindex) indicating a position of a starting resource block of a resource block set allocated for transmitting a paging message to the MTC user equipment and second information (e.g., the above-described numberofprb) indicating the number of consecutively allocated resource blocks included in the resource block set.

Optionally, the resource allocation indication information is carried by a system information block or an NAS message.

Preferably, the resource allocation indication information contains multiple pieces of the first information and multiple pieces of the second information respectively corresponding to different coverage enhancement levels.

The configuration module 24 may be configured to apply the received resource allocation indication information.

Preferably, the configuration module 24 is further configured to set a lifespan for the received resource allocation indication information.

The configuration module may further be configured to, in a radio resource control connect RRC CONNECT state and/or in a radio resource control idle RRC IDLE state, maintain valid resource allocation indication information.

In some embodiments, the communication module 22 is further used for receiving a paging message. Particularly, the communication module 22 is further configured to receive a paging message according to the starting position of the paging message in the frequency domain and the number of physical resource blocks occupied by the paging message, determined based on the applied resource allocation indication information.

In some embodiments of the present invention, the MTC UE 20 further includes a memory module 26 used for storing the received information, for example, resource allocation information for a paging message, system information, a paging message, and the like.

The network node 10 and the MTC user equipment 20 can perform the frequency resource allocation method for a paging message of an MTC system described with reference to FIG. 1 above, and their functions and operations will not be repeatedly described herein.

The methods and related equipment according to the present invention have been described above in conjunction with preferred embodiments. It should be understood by those skilled in the art that the methods described above are only exemplary. The method according to the present invention is not limited to steps or sequences described above. The network node and the user equipment described above may include more modules, for example, may further include modules, which can be developed or to be developed in future, applied to a base station, an MME or a UE. Various identities shown above are only exemplary, not for limitation, and the present invention is not limited to the information elements served as examples of these identities. Many alterations and modifications can be made by those skilled in the art based on the teaching of the described embodiments.

In the embodiments of the present invention, the MTC user equipment can be informed of configuration parameters related to a paging message, so that the user equipment can obtain the paging message. Preferably, according to the embodiments of the present invention, the frequency domain resource alocation for the passing message of the MTC user equipment is transmitted for example in a system information block or an NAS message, so that the MTC user equipment still can determine a position of the paging message in the frequency domain and therefore obtain the paging message correctly in the case that there is no physical downlink control channel.

It should be understood that the above embodiments of the present invention may be implemented through software, hardware or a combination of software and hardware. For example, various components in the base station and the user equipment in the above embodiments may be implemented through various devices, including but not limited to an analog circuit device, a digital circuit device, a digital signal processing (DSP) circuit, a programmable processor, an application specific integrated circuit (ASIC), a field programmable gate array (FPGA), a programmable logic devices (CPLD), and the like.

In this application, the “base station” refers to a mobile communication data and control switching center with large transmission power and wide coverage area, including resource allocation scheduling, data receiving and transmitting and other functions. The “user equipment” refers to a user mobile terminal, such as a terminal device, that can perform wireless communication with a base station or a micro base station, including a mobile phone, a notebook, or the like. The “mobility management entity” refers to an entity able to manage the mobility of users in a core network.

In addition, the embodiments of the present invention, disclosed here, may be implemented on a computer program product. More specifically, the computer program product is described as below. The product has a computer-readable medium on which computer program logic is encoded. The computer program logic provides relevant operations to implement the above-described technical solution of the present invention when the product is executed on a computing device. The computer program logic enables a processor to execute the operations (methods) described in the embodiments of the present invention when the product is executed on at least one processor of a computing system. Such an arrangement of the present invention is typically provided as software, a code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database and on the like in one or more modules. Software or firmware or such configuration may be installed on a computing device such that one or more processors in the computing device perform the technical solutions described in the embodiments of the present invention.

Although the present invention has been described in connection with the preferred embodiments of the present invention, it will be understood by those skilled in the art that various modifications, substitutions and alterations may be made therein without departing from the spirit and scope of the present invention. Accordingly, the present invention should not be limited by the above-described embodiments, but should be limited by the appended claims and their equivalents.

1. A frequency domain resource allocation method for a paging message performed by a network node, comprising:
allocating a resource block set for transmitting a paging message to a machine type communication MTC user equipment; and
transmitting resource allocation indication information to the MTC user equipment,
wherein the resource allocation indication information comprises first information indicating a position of a starting resource block of the resource block set and second information indicating the number of consecutively allocated resource blocks contained in the resource block set.

2. The method according to claim 1, wherein the network node is a base station or a mobility management entity MME.

3. The method according to claim 1, wherein the transmitting the resource allocation indication information to the MTC user equipment comprises:
carrying the resource allocation indication information by a system information block; or
carrying the resource allocation indication information by a non access stratum NAS message.

4. The method according to claim 1, wherein the resource allocation indication information contains a plurality of pieces of the first information and a plurality of pieces of the second information corresponding to different coverage enhancement levels.

5. A frequency domain resource allocation method for a paging message, with a machine type communication MTC user equipment as a receiver, comprising:
receiving, from a network node, resource allocation indication information for a paging message, wherein the resource allocation indication information comprises first information indicating a position of a starting resource block of a resource block set allocated for transmitting the paging message to the MTC user equipment and second information indicating the number of consecutively allocated resource blocks contained in the resource block set; and
applying the received resource allocation indication information.

6. The method according to claim 5, wherein the network node is a base station or a mobility management entity MME.

7. The method according to claim 5, wherein the resource allocation indication information is carried by a system information block or a non access stratum NAS message.

8. The method according to claim 5, wherein the resource allocation indication information contains a plurality of pieces of the first information and a plurality of pieces of the second information corresponding to different coverage enhancement levels.

9. The method according to claim 5, further comprising: setting a lifespan for the received resource allocation indication information.

10. The method according to claim 5, further comprising: maintaining valid resource allocation indication information in an RCC CONNECT state and/or in an RCC IDLE state.

11. The method according to claim 5, further comprising: determining a starting position of the paging message in a frequency domain and the number of physical resource blocks occupied by the paging message according to the applied resource allocation indication information, to receive the paging message.

12. A network node in a wireless telecommunication system supporting machine type communication MTC, comprising:
an allocation module, configured to allocate a resource block set for transmitting a paging message to an MTC user equipment; and
a communication module, configured to transmit resource allocation indication information to the MTC user equipment, wherein the resource allocation indication information comprises first information indicating a position of a starting resource block of the resource block set and second information indicating the number of consecutively allocated resource blocks contained in the resource block set.

13. The network node according to claim 12, wherein the network node is a base station or a mobility management entity MME.

14. The network node according to claim 12, wherein the communication module is further configured to:
carry the resource allocation indication information by a system information block; or
carry the resource allocation indication information by a non access stratum NAS message.

15. The network node according to claim 12, wherein the resource allocation indication information contains a plurality of pieces of the first information and a plurality of pieces of the second information corresponding to different coverage enhancement levels.

16. A machine type communication MTC user equipment, comprising:
a communication module, configured to receive, from a network node, resource allocation indication information for a paging message, wherein the resource allocation indication information comprises first information indicating a position of a starting resource block of a resource block set allocated for transmitting the paging message to the MTC user equipment and second information indicating the number of consecutively allocated resource blocks contained in the resource block set; and
a configuration module, configured to apply the received resource allocation indication information.

17. The MTC user equipment according to claim 16, wherein the network node is a base station or a mobility management entity MME.

18. The MTC user equipment according to claim 16, wherein the resource allocation indication information is carried by a system information block or a non access stratum NAS message.

19. The MTC user equipment according to claim 16, wherein the resource allocation indication information contains a plurality of pieces of the first information and a plurality of pieces of the second information corresponding to different coverage enhancement levels.

20. The MTC user equipment according to claim 16, wherein the configuration module is further configured to set a lifespan for the received resource allocation indication information.

21. The MTC user equipment according to claim 16, wherein the configuration module is further configured to, in a radio resource control connect RRC CONNECT state and/or in a radio resource control idle RRC IDLE state, maintain valid resource allocation indication information.

22. The MTC user equipment according to claim 16, wherein the communication module is further configured to receive the paging message according to a starting position of the paging message in the frequency domain and the number of physical resource blocks occupied by the paging message, determined according to the applied resource allocation indication information.
